(19) United States
(12) Patent Application Publication
(10) Pub. No.: US 2008/0003026 A1
(43) Pub. Date: Jan. 3, 2008

(54) Image fixing unit for an image forming apparatus

(75) Inventor: Dong-Jin Seol, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/602,987

(22) Filed: Nov. 22, 2006

(30) Foreign Application Priority Data
Jul. 3, 2006 (KR) 2006-61932

(51) Int. Cl. G03G 15/20

(52) U.S. Cl. 399/329

(57) ABSTRACT

An image fixing unit for use in an image forming apparatus for fixing a toner image on a printable medium is provided. The image fixing unit includes a heat roller in which a heater is mounted, a circulating belt tightly engaged with the heat roller and forming a nip through which a printable medium passes, a plurality of guide rollers supporting the circulating belt for rotation of the circulating belt, and bushings formed on both ends of each guide roller and having a regulating portion for preventing the circulating belt from meandering. Protrusions are formed on a surface of the bushings contacting the circulating belt to reduce a contact area between the circulating belt and the bushings. Therefore, the contact area between the traveling circulating belt and the bushings, which are fixed components of the guide rollers, is reduced and wear and tear of the circulating belt and a drive torque for driving the image fixing unit are also thus reduced.

### CROSS-REFERENCE TO RELATED APPLICATIONS

This application claims all benefits accruing under 35 U.S.C. §119 from Korean Patent Application No. 2006-61932, filed Jul. 3, 2006, in the Korean Intellectual Property Office, the disclosure of which is incorporated herein by reference.

### BACKGROUND OF THE INVENTION

1. Field of the Invention

The present invention relates to an image forming apparatus, and more particularly, to an image fixing unit of an image forming apparatus for fusing a toner image transferred to a printable medium using heat and pressure.

2. Related Art

Generally, in an image forming apparatus using an electro-photographic process, such as a laser beam printer, a photo-copier, a facsimile machine or a multi-functional product, a toner image is developed in a developing unit, transferred to a printable medium, such as a paper, and then fused by heat and pressure in an image fixing unit. That is, a toner image formed in the developing unit is transferred onto the printable medium, and the toner image is then fused by heat and pressure on the printable medium to render a developed image permanent such that the toner image cannot be spread or smudged even by rubbing with hands. Typically, such an image fixing unit utilizes a structure where two rollers are tightly engaged by strong pressure. That is, when the printable medium passes between the two rollers, the transferred toner image is heated by a heater mounted in any one of the two rollers arranged inside the image fixing unit to be fused onto the printable medium.

However, as printing speeds of image forming apparatuses become progressively higher and faster, roller type image fixing units cannot supply enough heat for fusing. This is because the amount of time the printable medium stays between the two rollers arranged inside the roller type image fixing unit is decreased due to the higher printing speed. As a result, the printable medium may pass through the two rollers to be discharged before the fusing is completed. In other words, there is a limit in printing speeds using a roller type image fixing unit due to a staying time that a printable medium is required to stay between the two rollers for high-speed image formation. Meanwhile, when a diameter of the roller becomes dramatically larger to counteract this effect, the size of an image forming apparatus becomes so large, and it takes too long to warm up.

Therefore, in order to address such a drawback, an image fixing unit of a belt type has been recently employed, as shown in FIG. 1, in which a belt is utilized to engage a heat roller. Referring to FIG. 1, a perspective view of a typical belt type image fixing is shown. In such a belt type image fixing unit, a circulating belt 20 is used instead of a roller as a member which is tightly engaged with a heat roller 30 in which a heater (not shown) is mounted. As a result, a length of a nip N, which a printable medium passes through, while receiving heat from the heat roller 30, is greatly increased. That is, since the nip N formed by tight engagement of the circulating belt 20 with the heat roller 30 is much longer than a nip formed by engagement of two rollers, sufficient staying time can be obtained even when an image forming apparatus form images at a high printing speed.

As shown in FIG. 1, the belt type image fixing unit comprises a circulating belt 20, guide rollers 11 and 12 which guide rotation of the circulating belt 20, engaging springs 13 and 14 which provide elasticity such that the guide rollers 11 and 12 are tightly engaged with the heat roller 30, and a tension spring 15 which can enlarge an interval between the guide rollers 11 and 12 such that a tight tension is applied to the circulating belt 20. Of the guide rollers 11 and 12, the roller 11 arranged at an entrance side may be called a pressure roller, and the roller 12 arranged at an exit side may be called a separating roller. Both the entrance side and the exit side are based on a fusing direction of a printable medium 1. Since a hardness of the separating roller 12 is higher than that of a rubber layer on an outer circumference of the heat roller 30, the separating roller 12 forms a nip N such that a leading end of the printable medium 1 is not rolled around the heat roller 30, but moves away from the heat roller 30, when exiting the image fixing unit, as shown in FIG. 2.

Bushings 10 are coupled to both end portions of the guide rollers (i.e., pressure and separating rollers) 11 and 12 to prevent the circulating belt 20 from meandering. The bushings 10 serve as a coupling portion of the springs 13, 14 and 15, while rotatably supporting the guide rollers 11 and 12. Also, since regulating portions 10a are formed on the end portions of the guide rollers 11 and 12, the circulating belt 20 is prevented from meandering over the bushings 10, as shown in FIG. 3.

However, the bushings 10 are fixed, which affect the rotation of the circulating belt 20. That is, the circulating belt 20 circulates while contacting the bushings 10 as well as bodies 11a and 12a of the guide rollers 11 and 12, as shown in FIG. 3. At this point, the bodies 11a and 12a of the guide rollers 11 and 12 rotate together with the circulating belt 20, but the bushings 10 are fixed, thereby continually producing friction with the circulating belt 20. Such a continuous friction wears down the circulating belt 20, and reduces the lifespan of the circulating belt 20. In addition, as the circulating belt 20 is generally driven by rotation of the heat roller 30, a drive torque for the heat roller 30 is unnecessarily high, because the friction operates as a resistive force.

Therefore, a new structure of an image fixing unit for use in an image forming apparatus capable of reducing friction between the circulating belt 20 and the bushings 10 is required in order to alleviate the above-mentioned problems.

### SUMMARY OF THE INVENTION

Several aspects and example embodiments of the present invention provide an image fixing unit for use in an image forming apparatus having a new and improved structure which minimizes friction between a circulating belt, which rotates while forming a nip with a heat roller, and a bushing mounted to a guide roller.

Additional aspects and/or advantages of the invention will be set forth in part in the description which follows and, in part, will be obvious from the description, or may be learned by practice of the invention.

In accordance with an embodiment of the present invention, there is provided an image fixing unit for use in an image forming apparatus including: a heat roller in which a heater is mounted; a circulating belt tightly engaged with the heat roller and forming a nip through which a printable medium passes; and a plurality of guide rollers to support the circulating belt to rotate along with the heat roller, wherein a protrusion is formed on a surface outside a body of the guide roller, the surface making friction contact with the circulating belt when the circulating belt rotates.

In accordance with another embodiment of the present invention, there is provided an image forming apparatus including: a developing unit arranged to develop a toner image and transfer the toner image to a printable medium; and an image fixing unit arranged to fix (fuse) the transferred toner image by heat and pressure onto the printable medium, wherein the image fixing unit comprises: a heat roller in which a heater is mounted; a circulating belt tightly engaged with the heat roller and forming a nip through which the printable medium passes; and a plurality of guide rollers arranged to support the circulating belt to rotate along the heat roller, wherein a protrusion is formed on a surface outside a body of the guide roller, the surface making friction contact with the circulating belt when the circulating belt rotates.

According to an aspect of the present invention, bushings, which include a regulating portion for preventing the circulating belt from meandering, may be mounted in both ends of each guide roller, and the surface on which the protrusion may be formed is a surface of the bushings.

According to another aspect of the present invention, the protrusion may be formed in a dome shape, and a plurality of protrusions may be formed on the surface of the bushings contacting the circulating belt. The protrusions may satisfy an equation “0.05 mm≦R1≦R2”, where R1 indicates a radius of curvature of the protrusions taken along a shaft direction of the guide roller, and R2 indicates a radius of curvature of the protrusions taken along a traveling direction of the circulating belt.

According to yet another aspect of the present invention, the plurality of protrusions may be not aligned in lines in a shaft direction of the guide roller, but are disposed in a zigzag pattern. A space may be formed in the protrusion, and a ball may be rotatably formed in the space of the protrusion.

According to yet another aspect of the present invention, the protrusion may be formed in a ring shape along an outer circumference of the contact surface of the guide rollers.

In accordance with yet another embodiment of the present invention, an image forming apparatus is provided with a developing unit arranged to develop a toner image and transfer the toner image onto a printable medium; and an image fixing unit arranged to fix the transferred toner image permanently on the printable medium by heat and pressure, wherein the image fixing device comprises: a heat roller in which a heater is mounted; a circulating belt arranged to cyclically rotate along with the heat roller, and form a nip through which the printable medium passes through when engaged with the heat roller; guide rollers arranged to support the circulating belt and provided with main bodies to rotate along with the heat roller; bushings coupled to both end portions of the guide rollers and fixed to support the guide rollers; regulating portions formed at both end portions of the guide rollers to prevent the circulating belt from meandering over the bushings; and a plurality of protrusions formed on part of surfaces of the bushings that are in contact with the circulating belt, adjacent to surfaces of main bodies of the guide rollers which rotate along with the circulating belt.

According to an aspect of the present invention, each of the protrusions may be formed in a ring shape around an outer circumference of the surface outside the main body of each of the guide rollers. Alternatively, each of the protrusions has one of a dome shape, an elliptical dome shape, a cylindrical shaped body with a domed top, and a rectangular shaped body with a domed top.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a perspective view of a typical belt type image fixing unit;

FIG. 2 is a cross-sectional view of a structure of a nip of the image fixing unit shown in FIG. 1;

FIG. 3 is an end view of a structure of a guide roller of the image fixing unit shown in FIG.

FIG. 4 is a perspective view of a structure of an image fixing unit for use in an image forming apparatus according to an embodiment of the present invention;

FIG. 5 is an enlarged cut away view of a bushing, which is a main part of the image fixing unit, shown in FIG. 4, according to an embodiment of the present invention;

FIGS. 6A through 6D and 8 are views of various examples of shapes of a protrusion shown in FIG. 5 according to an embodiment of the present invention;

FIG. 7A is a friction torque versus contact area graph of a belt and a bushing according to an embodiment of the present invention;

FIG. 7B is a graph showing the relationship between the radius of curvature of a protrusion and an incidence of damage to a belt; and

FIG. 9 is a view showing a structure of an image fixing unit for use in an image forming apparatus according to another embodiment of the present invention.

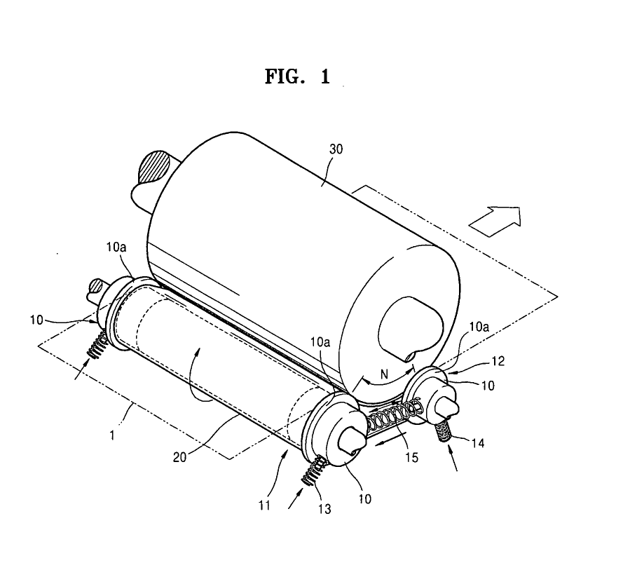

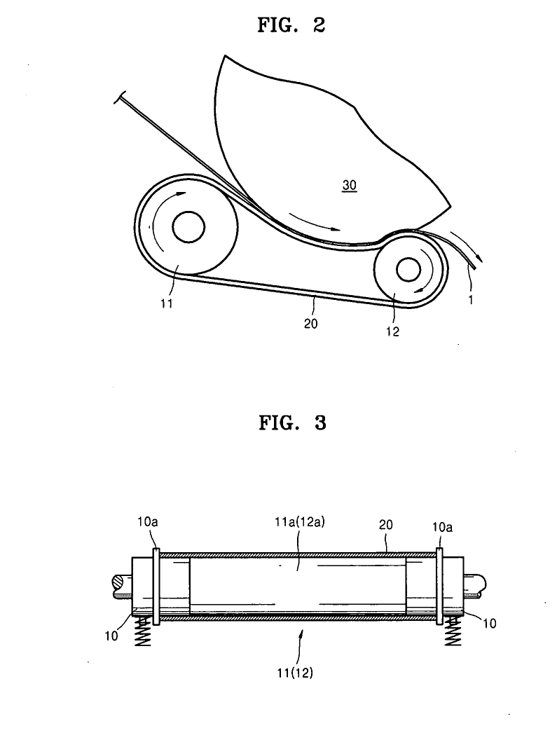

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

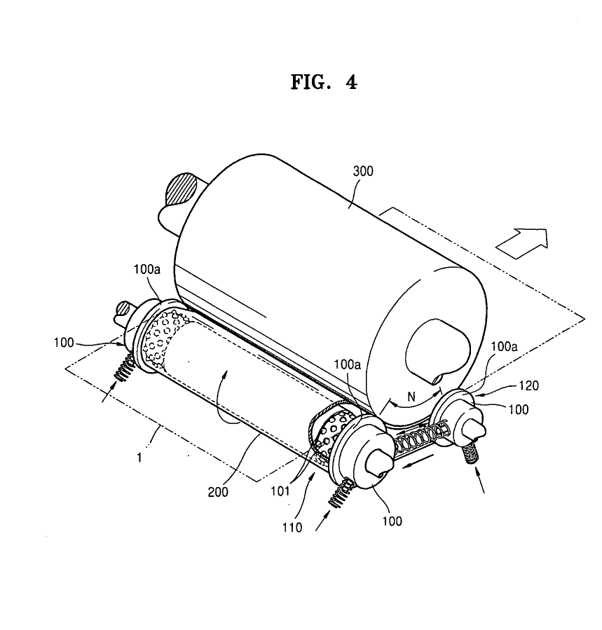

FIG. 4 is a perspective view of a structure of an image fixing unit for use in an image forming apparatus according to an embodiment of the present invention. As previously discussed, the image forming apparatus can be a laser beam printer, a photo-copier, a facsimile machine or a multi-functional product.

Referring to FIG. 4, the image fixing unit has a belt type structure, and includes a heat roller 300 in which a heater (not shown) is mounted and a circulating belt 200, which is cyclically rotated, while forming a long nip N when engaged with the heat roller 300. A printable medium 1, such as a paper, to which a toner image is transferred onto by a developing unit (not shown), receives heat due to a high temperature of the heat roller 300 simultaneously with undergoing a high pressure from the circulating belt 200 when passing through the nip N. As a result, the toner image is completely fused by heat and pressure.

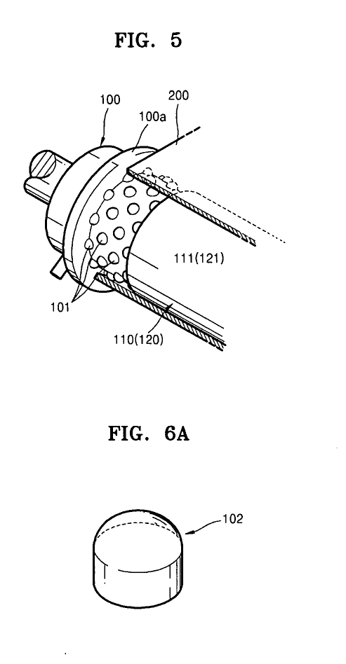

Guide rollers 110 and 120 support the circulating belt 200 to stably rotate, while maintaining a tight tension, and bushings 100 of the guide rollers 110 and 120 have a structure which reduces friction with the circulating belt 200. Each of the bushings 100 is not a rotary component which rotates together with the circulating belt 200. Rather, each of the bushings 100 is a fixed component for preventing the circulating belt 200 from meandering by means of a regulating portion 100a while supporting the rotation of bodies 111 and 121 of the guide rollers 110 and 120. Therefore, in the embodiments of present embodiment, to minimize friction by reducing a contact area between the circulating belt 200 and the guide rollers 110 and 120, a plurality of protrusions 101 having a dome shape are formed on a surface of the bushing 100 contacting the circulating belt 200 as shown in FIGS. 4 and 5. That is, a plurality of protrusions 101 are formed on the contact surface between the circulating belt 200 and the bushings 100, so that the circulating belt 200 passes, while touching the protrusions 101. Therefore, a contact area is greatly reduced in comparison to the case without the protrusions 101, and thus a friction is significantly reduced. Also, the protrusions 101 are not aligned in lines in a shaft direction of the guide rollers 110 and 120, but are disposed in a zigzag pattern. Accordingly, the circulating belt 200 can rotate more smoothly over the protrusions 101 formed in a zigzag pattern, although it makes point contact with the protrusions 101.

Therefore, both end portions of the circulating belt 200 contact very small areas of tops of the protrusions 101, thereby reducing a friction between the circulating belt 200 and the bushing 100, and thus reducing a wearing amount of the circulating belt 200 and a driving torque required to drive the image fixing device.

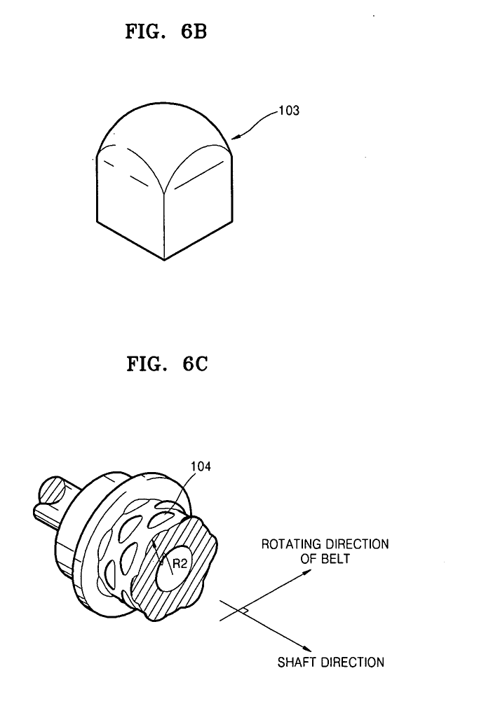

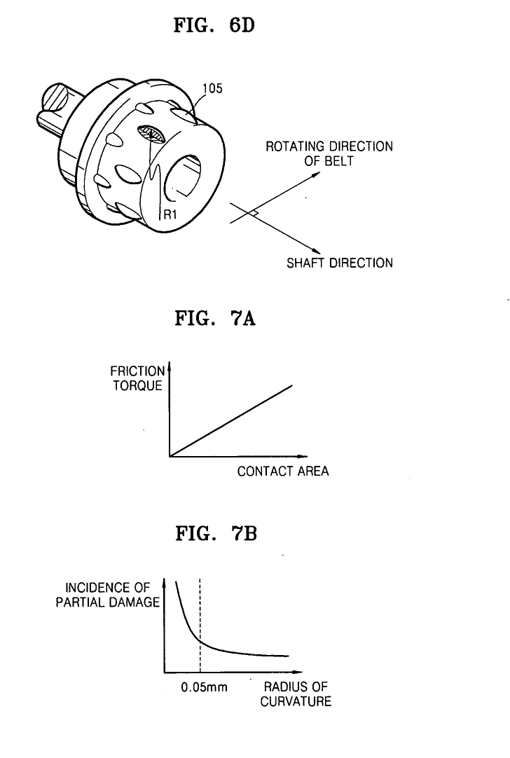

In the present embodiment shown in FIG. 5, the protrusions 101 have a dome shape; however, the protrusions 101 can have other shapes as well. For example, protrusions 102 with a cylindrical shaped body having a domed top can be used as shown in FIG. 6A, or protrusions 103 with a rectangular shaped body having a domed top can be used as shown in FIG. 6B. Further, instead of the semicircular dome shape, an elliptical dome shape can be used similarly in protrusions 104 and 105 shown in FIGS. 6C and 6D.

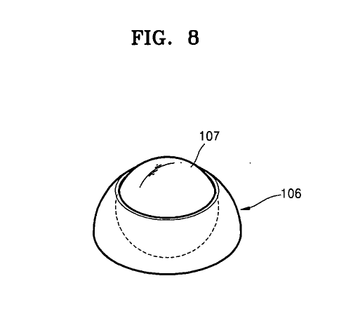

However, in terms of reducing friction, the pattern shown in FIG. 6C, or a dome shape shown in FIGS. 5 through 6B, are more efficient than the pattern shown in FIG. 6D. This is because, as shown in FIG. 6D, when protrusions 105 are elongated in a shaft direction that is perpendicular to a rotating direction of the circulating belt 200, contact areas of tops of the protrusions 105 producing frictions may be significantly enlarged. Therefore, if R1 shown in FIG. 6D indicates a radius of curvature of the protrusion taken along a shaft direction of the guide rollers 110 and 120, and R2 shown in FIG. 6C indicates a radius of curvature of the protrusion taken along a rotation direction, it is advantageous to determine the protrusion shape to satisfy an equation “R1≦R2”. However, when a radius of curvature of the protrusions 101 through 105 becomes too small to decrease a contact area with the circulating belt 200, the protrusions become pointed at the end, and thus may scratch the circulating belt 200. In other words, a friction torque decreases in proportion to a contact area as shown in FIG. 7A, while an incidence of partial damage such a scratch in the circulating belt 200 increases in an inverse proportion to the radius of curvature as shown in FIG. 7B. In particular, when the radius of curvature is below 0.05 mm, an amount of scratching rapidly increases. Accordingly, when a shape of the protrusions 101˜105 is determined to satisfy an equation “0.05 mm≦R1≦R2”, friction can be decreased and scratching can be prevented. Alternatively, as shown in FIG. 8, when a space is formed in a protrusion 106 and a ball 107 is rotatably disposed in the space, the resulting structure serves as a ball bearing, and thus can support more smoothly movement of the circulating belt 200.

The protrusions 101, 102, 103, 104, 105 and 106, as shown in FIG. 4, FIG. 5, FIGS. 6A-6D, and FIG. 8, should be aligned such that tops thereof are as high as the bodies 111 and 121 of the guide rollers 110 and 120.

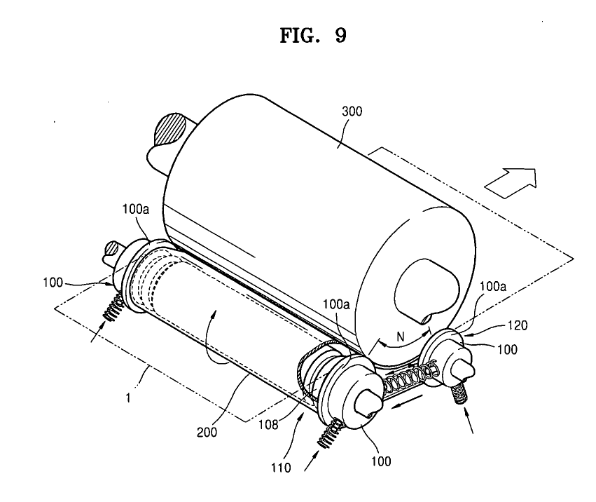

Turning now to FIG. 9, an image fixing unit for use in an image forming apparatus according to another embodiment of the present invention is illustrated. In the image fixing unit of the current embodiment, a protrusion 108 formed on a bushing 100 of guide rollers 110 and 120 is not formed as a plurality of separated dome shapes. Rather, such a protrusion 108 is formed as a ring shape along an outer circumference of the bushing 100. That is, a circulating belt 200 may be supported by a plurality of small protrusions as in the previous embodiments, shown in FIG. 4, FIG. 5, FIGS. 6A-6D, and FIG. 8, or by the protrusion 108 of a ring shape as the current embodiment. Likewise, a contact area with the circulating belt 200 is decreased in comparison to the bushing 100 without the protrusion 108, thereby reducing wear and tear of the circulating belt 200 and a required drive torque for driving the image fixing unit. In addition, the protrusion 108 should have the same height as the bodies 111 and 121 of the guide rollers 110 and 120 such that the circulating belt 200 rotates smoothly.

Therefore, a contact area between the bushing 100, which is a fixed component, and the circulating belt 200 may decrease, thereby alleviating the problems caused due to friction.

As described above, in the image fixing unit for use in an image forming apparatus of the present invention, the protrusions formed on a surface of the bushing reduces a contact area between the rotating circulating belt and the bushing, which is a fixed component, of the guide rollers, thereby reducing wear and tear of the circulating belt and a drive torque for driving the image fixing device.

While the present invention has been particularly shown and described with reference to exemplary embodiments thereof, it will be understood by those of ordinary skill in the art that various changes in form and details may be made therein without departing from the spirit and scope of the present invention. Many modifications, permutations, additions and sub-combinations may be made to adapt the teachings of the present invention to a particular situation without departing from the scope thereof. For example, protrusions can be configured to have different sizes and shapes than that shown in FIG. 5, FIG. 6A-6D and FIG. 8. In addition, the area on which the protrusions are formed can be made larger or smaller than that shown in FIG. 5 to ensure contact with the circulating belt. Accordingly, it is intended, therefore, that the present invention not be limited to the various example embodiments disclosed, but that the present invention includes all embodiments falling within the scope of the appended claims.

What is claimed is:

1. An image fixing unit for use in an image forming apparatus, comprising:
a heat roller in which a heater is mounted;
a circulating belt engaged with the heat roller, and forming a nip through which a printable medium passes; and
a plurality of guide rollers arranged to support the circulating belt to rotate along with the heat roller,
wherein a protrusion is formed on a surface outside a body of the guide roller, the surface contacting with the circulating belt, when the circulating belt is rotated.

2. The image fixing unit as claimed in claim 1, wherein bushings, which include a regulating portion for preventing the circulating belt from meandering, are mounted on both ends of each guide roller and the surface on which the protrusion is formed is a surface of the bushings.

3. The image fixing unit as claimed in claim 2, wherein a plurality of protrusions are formed on the surface of the bushings contacting the circulating belt to reduce a contact area between the circulating belt and the guide rollers, and wherein each protrusion is formed in a dome shape.

4. The image fixing unit as claimed in claim 3, wherein the protrusions satisfy an equation “0.05 mm≦R1≦R2”, where R1 indicates a radius of curvature of the protrusions taken along a shaft direction of the guide roller, and R2 indicates a radius of curvature of the protrusions taken along a traveling direction of the circulating belt.

5. The image fixing unit as claimed in claim 3, wherein the plurality of protrusions are not aligned in lines in a shaft direction of the guide rollers, but are disposed in a zig-zag pattern.

6. The image fixing unit as claimed in claim 1, wherein a space is formed in the protrusion and a ball is rotatably formed in the space of the protrusion.

7. The image fixing unit as claimed in claim 1, wherein the protrusion is formed in a ring shape around an outer circumference of the surface outside the body of the guide roller.

8. An image forming apparatus comprising:
a developing unit to develop a toner image and transfer the toner image onto a printable medium; and
an image fixing unit arranged to fix the transferred toner image on the printable medium by heat and pressure, the image fixing device comprising:
a heat roller in which a heater is mounted;
a circulating belt engaged with the heat roller and forming a nip through which the printable medium passes; and
a plurality of guide rollers arranged to support the circulating belt to rotate along with the heat roller,
wherein a protrusion is formed on a surface outside a body of the guide roller, the surface contacting with the circulating belt when the circulating belt is rotated.

9. The image forming apparatus as claimed in claim 8, wherein bushings, which include a regulating portion for preventing the circulating belt from meandering, are mounted on both ends of each guide roller and the surface on which the protrusion is formed is a surface of the bushings.

10. The image forming apparatus as claimed in claim 9, wherein a plurality of protrusions are formed on the surface of the bushings contacting the circulating belt to reduce a contact area between the circulating belt and the guide rollers, and wherein each protrusion is formed in a dome shape.

11. The image forming apparatus as claimed in claim 10, wherein the protrusions satisfy an equation “0.05 mm≦R1≦R2”, where R1 indicates a radius of curvature of the protrusions taken along a shaft direction of the guide roller and R2 indicates a radius of curvature of the protrusions taken along a traveling direction of the circulating belt.

12. The image forming apparatus as claimed in claim 10, wherein the plurality of protrusions are not aligned in lines in a shaft direction of the guide rollers, but are disposed in a zig-zag pattern.

13. The image forming apparatus as claimed in claim 8, wherein a space is formed in the protrusion and a ball is rotatably formed in the space of the protrusion.

14. The image forming apparatus as claimed in claim 8, wherein the protrusion is formed in a ring shape around an outer circumference of the surface outside the body of each of the guide rollers.

15. The image fixing unit as claimed in claim 1, wherein the guide rollers are provided with bushings coupled to both end portions of the guide rollers and fixed to the image forming apparatus to support the guide rollers, and regulating portions formed at both end portions of the guide rollers to prevent the circulating belt from meandering over the bushings.

16. The image fixing unit as claimed in claim 15, wherein a plurality of protrusions are formed on part of surfaces of the bushings that are in contact with the circulating belt, adjacent to surfaces of main bodies of the guide rollers which rotate along with the circulating belt.

17. The image fixing unit as claimed in claim 16, wherein each of the protrusions has one of a dome shape, an elliptical dome shape, a cylindrical shaped body with a domed top, and a rectangular shaped body with a domed top.

18. The image forming apparatus as claimed in claim 8, wherein the guide rollers are provided with bushings coupled to both end portions of the guide rollers and fixed to the image forming apparatus to support the guide rollers, and regulating portions formed at both end portions of the guide rollers to prevent the circulating belt from meandering over the bushings.

19. The image forming apparatus as claimed in claim 18, wherein a plurality of protrusions are formed on part of surfaces of the bushings that are in contact with the circulating belt, adjacent to surfaces of main bodies of the guide rollers which rotate along with the circulating belt.

20. The image forming apparatus as claimed in claim 19, wherein each of the protrusions has one of a dome shape, an elliptical dome shape, a cylindrical shaped body with a domed top, and a rectangular shaped body with a domed top.

21. An image forming apparatus comprising:
a developing unit arranged to develop a toner image and transfer the toner image onto a printable medium; and
an image fixing unit arranged to fix the transferred toner image on the printable medium by heat and pressure, the image fixing device comprising:
a heat roller in which a heater is mounted;
a circulating belt arranged to cyclically rotate along with the heat roller, and form a nip through which the printable medium passes through when engaged with the heat roller;
guide rollers arranged to support the circulating belt and provided with main bodies to rotate along with the heat roller;
bushings coupled to both end portions of the guide rollers and fixed to support the guide rollers;
regulating portions formed at both end portions of the guide rollers to prevent the circulating belt from meandering over the bushings; and
a plurality of protrusions formed on part of surfaces of the bushings that are in contact with the circulating belt, adjacent to surfaces of main bodies of the guide rollers which rotate along with the circulating belt.

22. The image forming apparatus as claimed in claim 21, wherein the protrusions satisfy an equation “0.05 mm≦R1≦R2”, where R1 indicates a radius of curvature of the protrusions taken along a shaft direction of the guide roller and R2 indicates a radius of curvature of the protrusions taken along a traveling direction of the circulating belt.

23. The image forming apparatus as claimed in claim 21, wherein the plurality of protrusions are not aligned in lines in a shaft direction of the guide rollers, but are disposed in a zig-zag pattern.

24. The image forming apparatus as claimed in claim 21, wherein each of the protrusions is provided with a space and a ball is rotatably formed in the space of the protrusion.

25. The image forming apparatus as claimed in claim 21, wherein each of the protrusions is formed in a ring shape around an outer circumference of the surface outside the main body of each of the guide rollers.

26. The image forming apparatus as claimed in claim 21, wherein each of the protrusions has one of a dome shape, an elliptical dome shape, a cylindrical shaped body with a domed top, and a rectangular shaped body with a domed top.
